(19) United States
(12) Patent Application Publication
(10) Pub. No.: US 2014/0017586 A1
(43) Pub. Date: Jan. 16, 2014

(54) FUEL CELL APPARATUS AND DRIVING METHOD THEREOF, AND COMPLEX CARTRIDGE FOR THE SAME

(71) Applicant: SAMSUNG SDI CO., LTD., Yongin-si (KR)

(72) Inventors: Jong-Rock CHOI, Yongin-si (KR); Jin-Suk HEO, Yongin-si (KR); Young-Jae KIM, Yongin-si (KR)

(73) Assignee: SAMSUNG SDI CO., LTD., Yongin-si (KR)

(21) Appl. No.: 13/745,482

(22) Filed: Jan. 18, 2013

(30) Foreign Application Priority Data
Jul. 10, 2012 (KR) 10-2012-0075266

(51) Int. Cl. H01M 8/04

(52) U.S. Cl. CPC H01M 8/04447; H01M 8/04201; H01M 8/04798
USPC 429/449; 429/515

(57) ABSTRACT

A fuel cell apparatus includes: a fuel cell stack comprising a plurality of unit cells; a mixer storing a fuel mixture solution supplied to the fuel cell stack; a mixture solution sensor measuring a residual amount of the fuel mixture solution stored in the mixer; a mixture solution control pump capable of supplying the fuel mixture solution stored in a cartridge to the mixer or withdrawing the fuel mixture solution stored in the mixer to the cartridge in order to adjust a quantity of fuel mixture solution in the mixer; and a control unit receiving a residual measurement signal from the mixture solution sensor indicating both quantity and fuel concentration of the fuel mixture solution stored in the mixer, and driving the mixture solution control pump to effect the desired quantity and fuel concentration of the fuel mixture solution in the mixer.

This application makes reference to, incorporates the same herein, and claims all 6 benefits accruing under 35 U.S.C. §119 from an application for FUEL CELL APPARATUS AND DRIVING METHOD THEREOF, AND COMPLEX CARTRIDGE FOR THE SAME earlier filed a in the Korean Intellectual Property Office on 10 Jul. 2012 and there duly assigned Serial No. 10-2012-0075266.

### BACKGROUND OF THE INVENTION

1. Field of the Invention

The present invention relates to a fuel cell apparatus and a driving method thereof and a complex cartridge for the same. More particularly, the present invention relates to a fuel cell apparatus of a direct methanol fuel cell, a driving method thereof and a complex cartridge for the same.

2. Description of the Related Art

A fuel cell is a power generation system that generates electrical energy by means of electrochemical reaction between hydrogen contained in a hydrocarbon-based material, such as methanol, ethanol, or natural gas, and oxygen from the air.

Fuel cells can be classified as phosphoric acid fuel cells (PAFC), molten carbonate fuel cells (MCFS), solid oxide fuel cells (SOFC), polymer electrolyte membrane fuel cells (PEMFC), alkaline fuel cells (AFC), etc., depending on the type of electrolyte used. These respective fuel cells operate on the same basic principle, but differ in the types of fuels used, operating temperatures, catalysts, electrolytes, etc.

Since a polymer electrolyte membrane fuel cell (PEMFC) uses an ion-exchange membrane made of a solid polymer as an electrolyte, the PEMFC has no risk of corrosion or evaporation caused by the electrolyte. The polymer electrolyte membrane fuel cell has high a output density and high energy transformation efficiency and is operable at a low temperature of 80° C. or less. In addition, the polymer electrolyte membrane fuel cell can be miniaturized and sealed and thus it has been widely used as a power source for a variety of applications such as for a pollution-free vehicle, home power equipment, mobile communication equipment, military equipment, medical equipment, and the like.

In particular, a fuel cell that uses an ion-exchange membrane made of a solid polymer as an electrolyte is exemplified by a direct methanol fuel cell (DMFC). The direct methanol fuel cell is similar to the polymer electrolyte membrane fuel cell but is able to supply a liquid phase methanol fuel directly to a stack. Since, unlike the polymer electrolyte methanol fuel cell, the direct methanol fuel cell does not use a reformer for obtaining hydrogen from fuel but directly uses a liquid-phase fuel and is operable at a temperature below 100° C., the direct methanol fuel cell is more suitable as a power source for a small-sized electronic device or for a portable electronic device.

The methanol of a liquefied fuel reacts with water in a one to one mole ratio such that a high concentration fuel of methanol-water in a one to one mole ratio may be used. However, when using the high concentration mixture solution of methanol:water in a one to one mole ratio, output is decreased by crossover of the fuel through the electrolyte membrane. Methanol can pass through the electrolyte membrane to be consumed at the cathode. To counteract this crossover effect, the direct methanol fuel cell system uses a low concentration methanol mixture solution of 2-8 vol %.

If the direct methanol fuel cell is used in a high temperature environment (a temperature of more than about 45° C.) or is stored for a long time, the fuel mixture solution inside the direct methanol fuel cell system can evaporate. If the direct methanol fuel cell a system is operated with too little fuel mixture solution in place, deterioration of the fuel cell stack is accelerated.

To compensate the fuel mixture solution inside the direct methanol fuel cell system, a mixture solution compensation cartridge including the low concentration methanol mixture solution can be installed to the direct methanol fuel cell system. If, when supplementing the fuel mixture solution, a fuel cartridge including pure methanol is installed to the direct methanol fuel cell system by mistake, irreversible damage can occur.

In the high temperature environment, the direct methanol fuel cell system can be operated by using the cartridge including the high concentration methanol mixture solution of about 50 vol %. However, when using the cartridge including the high concentration methanol mixture solution at less than room temperature, an overflow of the fuel mixture solution can be generated inside the direct methanol fuel cell system.

Therefore, the user must always select the cartridge including the low concentration methanol mixture solution or the cartridge including the high concentration methanol mixture solution in accordance with the surrounding temperature.

The above information disclosed in this Background section is presented only for enhancement of understanding of the background of the invention and to facilitate implementation thereof, and therefore it may contain information that does not constitute prior art that is already known to a person of ordinary skill in the art.

### SUMMARY OF THE INVENTION

The present invention provides a fuel cell apparatus that operates a fuel cell system in a stable way by preventing a shortage or an overflow of a fuel mixture solution, an automated method for driving the fuel cell apparatus that includes rebalancing the fuel mixture composition supplied to the fuel cell apparatus in order to provide a fuel mixture that includes a reference fuel portion that is optimal for the operation of the fuel cell, and a complex cartridge for the same.

A fuel cell apparatus according to exemplary embodiments of the present invention includes: a fuel cell stack including a plurality of unit cells; a mixer storing a fuel mixture solution supplied to the fuel cell stack; a mixture solution sensor measuring a residual amount of the fuel mixture solution stored in the mixer, a mixture solution control pump that can supply the fuel mixture solution stored in a cartridge to the mixer or withdraw the fuel mixture solution stored in the mixer to the cartridge; and a control unit receiving a residual volume measurement signal for the fuel mixture solution stored in the mixer from the mixture solution sensor, driving the mixture solution control pump to supply the fuel stored in the cartridge to the mixer if the residual quantity of the fuel mixture solution stored in the mixer is below a reference level, and driving the mixture solution control pump to withdraw the fuel mixture solution stored in the mixer to the cartridge if the quantity of the residual amount of the fuel mixture solution stored in the mixer exceeds the reference level.

A gas-liquid separator separating unreacted air and unreacted fuel exhausted from the fuel cell stack into a liquid and a gas can be further included.

A condenser condensing the gas separated in the gas-liquid separator to withdraw the unreacted fuel can be further included.

A cartridge mounting unit including an inlet connector connected to an outlet connector of the cartridge, and an identification sensor identifying the kind of cartridge can be further included.

A first mixture solution control valve connected to the mixture solution control pump, the condenser, and the inlet connector can be further included.

The identification sensor may include an identification button, and the kind of to mounted cartridge is identified through a push of the identification button when mounting the cartridge to the cartridge mounting unit.

The cartridge mounting unit may be mounted with one of a complex cartridge storing both a low concentration fuel mixture solution and pure fuel and a single cartridge storing the low concentration fuel mixture solution.

One of the complex cartridge and the single cartridge can include a button groove inserted with the identification button.

The complex cartridge of a first exemplary embodiment of the invention can include: a mixture solution storage unit storing the low concentration fuel mixture solution; a fuel storage unit storing the pure fuel; an outlet connector connected to the inlet connector; and a second mixture solution control valve communicating one of the mixture solution storage unit and the fuel storage unit with the outlet connector.

The control unit can control the second mixture solution control valve when supplying the fuel to the mixer to communicate the mixture solution storage unit and the outlet connector.

The control unit can control the second mixture solution control valve when withdrawing the fuel mixture solution from the mixer to communicate the mixture solution storage unit and the outlet connector.

The mixture solution sensor can measure the concentration of the fuel mixture solution stored in the mixer to transmit concentration measurement information to the control unit, and the control unit can control the second mixture solution control valve to communicate the fuel storage unit and the outlet connector if the concentration of the fuel mixture solution stored in the mixer is below the reference concentration.

A complex cartridge according to a second exemplary embodiment of the present it invention includes: a mixture solution storage unit storing a low concentration fuel mixture solution; a fuel storage unit storing a pure fuel; a connector connected to a cartridge mounting unit of a fuel cell apparatus; and a control valve communicating one of the mixture solution storage unit and the fuel storage unit with the connector.

If the fuel cell apparatus is mounted, the control valve can be a three-way valve that is electrically connected to the fuel cell apparatus such that one of the mixture solution storage unit and the fuel storage unit communicates with the connector according to the control of the fuel cell apparatus.

A button groove inserted with an identification button provided to the cartridge mounting unit of the fuel cell apparatus to identify a kind of the cartridge can be further included.

A method of driving a fuel cell apparatus using a complex cartridge including a mixture solution storage unit storing a low concentration fuel mixture solution and a fuel storage unit storing a pure fuel according to exemplary embodiments of the present invention includes: confirming a residual amount of the fuel mixture solution stored in the mixer, determining whether the quantity of the fuel mixture solution stored in the mixer is below a reference level; moving the low concentration fuel mixture solution from the mixture solution storage unit to the mixer to supplement the fuel mixture solution of the mixer if the quantity of the fuel mixture solution of the mixer is below the reference level; determining whether the quantity of the fuel mixture solution stored in the mixer exceeds the reference level; and moving the fuel mixture solution stored in the mixer to the mixture solution storage unit to decrease the fuel mixture level a in the mixer if the quantity of the fuel mixture solution stored in the mixer exceeds the reference level.

The step of confirming that a residual amount of the fuel mixture solution is stored in the mixer can include measuring a concentration of the fuel mixture solution stored in the mixer.

The method of driving a fuel cell apparatus can additionally include moving the pure fuel from the fuel storage unit to the mixer to make the concentration of the fuel mixture solution stored in the mixer reach the reference concentration if the concentration of the fuel mixture solution stored in the mixer is lower than the reference concentration.

The step of moving the low concentration fuel mixture solution from the mixture solution storage unit to the mixer and the step of moving the fuel mixture solution stored in the mixer to the mixture solution storage unit can be repeatedly performed while the fuel cell stack included in the fuel cell apparatus is operated in order to keep the level of the fuel mixture solution in the mixer near the reference level.

By continuously adjusting the fuel portion included in the fuel mixture, overflow of the fuel-depleted fuel mixture solution of the fuel cell system can be prevented, and the fuel cell system can be operated in a stable way.

### BRIEF DESCRIPTION OF THE DRAWINGS

FIG. 1 is a schematic block diagram of a fuel cell system according to an exemplary embodiment of the present invention.

FIG. 2 is a flowchart of a method for driving a fuel cell system according to an exemplary embodiment of the present invention.

### DETAILED DESCRIPTION OF THE INVENTION

Hereinafter, several embodiments of the present invention have been shown and a described in detail such that they can be easily performed by those skilled in the art with reference to the accompanying drawings. The present invention may be modified in various different ways and is not limited to embodiments described herein.

Further, in the embodiments, like reference numerals designate like elements throughout the specification. Many features are common to the various embodiments of the invention, and only features not described in the first embodiment are subsequently described.

In order to describe the present invention more clearly, parts that are not related to the description will be omitted from the drawings, and the same symbols will be given to similar parts throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

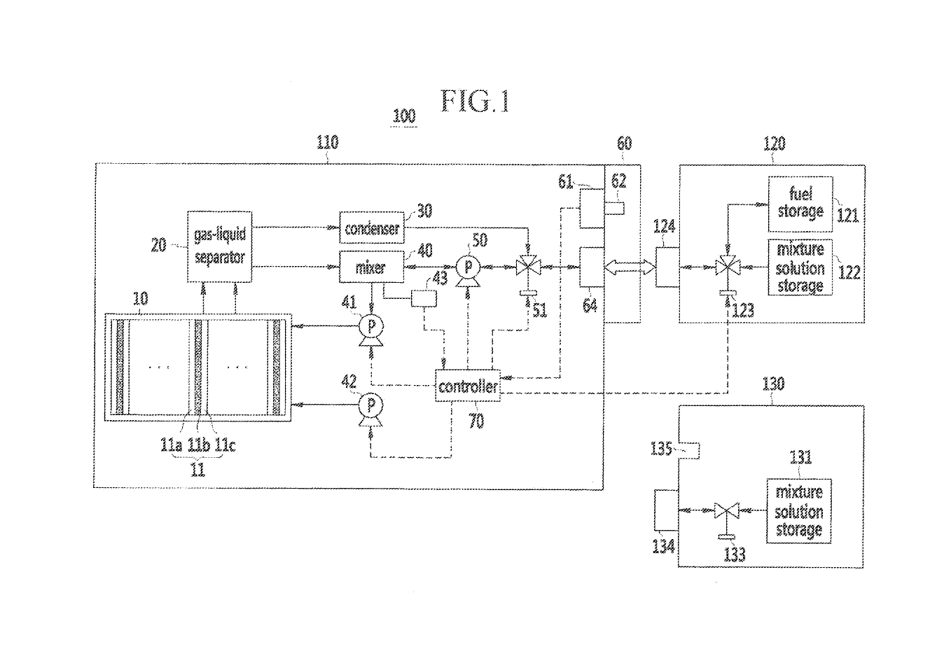

FIG. 1 is a schematic block diagram of a fuel cell system according to an exemplary embodiment of the present invention.

Referring to FIG. 1, a fuel cell system 100 can employ a direct methanol fuel cell (DMFC) that uses an ion exchange membrane made of a solid polymer as an electrolyte and directly supplies a methanol fuel to a fuel cell stack to generate electrical energy. The fuel cell system 100 may store a hydrocarbon-based fuel that is in a liquid phase or gas phase, such as a ethanol, natural gas, LPG, and the like as well as methanol.

The fuel cell system 100 includes a fuel cell apparatus 110 generating electrical energy and a cartridge supplying a fuel to the fuel cell apparatus 110. The cartridge supplying the fuel to the fuel cell apparatus 110 can be either a complex cartridge 120 storing a low concentration fuel mixture solution and a pure fuel or a single cartridge 130 storing the low concentration fuel mixture solution.

The fuel cell apparatus 110 includes a fuel cell stack 10, a gas-liquid separator 20, a condenser 30, a mixer 40, a fuel pump 41, an oxidant pump 42, a mixture solution sensor 43, a mixture solution control pump 50, a first mixture solution control valve 51, a cartridge mounting unit 60, an identification sensor 61, an identification button 62, an inlet connector 64, and a control unit 70.

The fuel cell stack 10 includes a plurality of unit cells guiding an oxidation/reduction reaction of the fuel and the oxidant to generate the electrical energy. One unit cell 11 of a plurality of unit cells includes a membrane-electrode assembly 11b, upon which fuel is oxidized at the anode and oxygen is reduced at the cathode, and separators (referred to as bipolar plates) 11a and 11c supplying fuel and oxidant to the membrane-electrode assembly 11b. The unit cell 11 has a structure in which the separators 11a and 11c are disposed at both sides with respect to the membrane-electrode assembly 11b. The membrane-electrode assembly 11b includes an electrolyte membrane disposed at the center, a cathode disposed at one side of the electrolyte membrane, and an anode disposed at the other side of the electrolyte membrane. The cathode is supplied with the oxidant through the separators 11a and 11c and the anode is supplied with the fuel.

The gas-liquid separator 20 separates unreacted air and unreacted fuel exhausted from the fuel cell stack 10 into a liquid and a gas. Moisture is included in the unreacted air exhausted from the fuel cell stack 10. The liquid separated from the gas-liquid separator 20 is transmitted to the mixer 40, and the separated gas is transmitted to the condenser 30. The gas-liquid separator 20 comprises a centrifugal pump or an electrokinetic pump.

The condenser 30 condenses the gas separated from the gas-liquid separator 20 to withdraw the unreacted fuel. The unreacted fuel condensed by the condenser 30 is transmitted to the mixer 40 through the first mixture solution control valve 51 and the mixture solution control pump 50.

The liquid exhausted from the gas-liquid separator 20 flows into the mixer 40. The liquid exhausted from the gas-liquid separator 20 is in a state such that unreacted fuel and moisture are mixed. Also, the low concentration fuel mixture solution or the pure fuel supplied from the complex cartridge 120 flows into the mixer 40, or the low concentration fuel mixture solution supplied from the single cartridge 130 flows into the mixer 40. Also, the unreacted fuel withdrawn in the condenser 30 flows into the mixer 40. Accordingly, the unreacted fuel and the moisture exhausted from the gas-liquid separator 20, the fuel mixture solution supplied from the complex cartridge 120 or the single cartridge 130, and the unreacted fuel withdrawn from the condenser 30 are mixed into a fuel mixture solution of an appropriate concentration in the mixer 40.

The fuel pump 41 is connected and installed to the mixer 40 to exhaust the fuel mixture solution stored in the mixer 40 from the mixer 40 by a predetermined pumping force. The fuel mixture solution exhausted from the mixer 40 is supplied to the fuel cell stack 10 by the fuel pump 41.

The oxidant pump 42 supplies the oxidant to the fuel cell stack 10. The oxidant a pump 42 absorbs external air by a predetermined pumping force to supply the external air to the fuel cell stack 10.

The mixture solution sensor 43 measures a concentration and a residual amount of the fuel mixture solution stored in the mixer 40. The mixture solution sensor 43 transmits measurement information regarding the concentration and the residual amount of the fuel mixture solution stored in the mixer 40 to the control unit 70.

The mixture solution control pump 50 is installed between the mixer 40 and the first mixture solution control valve 51. The mixture solution control pump 50 supplies the unreacted fuel condensed in the condenser 30 and the fuel mixture solution stored in the complex cartridge 120 or the single cartridge 130 to the mixer 40 by a predetermined pumping force. Also, the mixture solution control pump 50 withdraws the fuel mixture solution stored in the mixer 40 to the complex cartridge 120 by the predetermined pumping force.

The first mixture solution control valve 51 is a three-way valve connected to the mixture solution control pump 50, the condenser 30, and the inlet connector 64. The first mixture solution control valve 51 communicates the condenser 30 and the mixture solution control pump 50 to each other and the condenser 30 and the inlet connector 64 to each other according to control of the control unit 70.

The inlet connector 64 is connected to an outlet connector 124 provided to the complex cartridge 120 or an outlet connector 134 provided to the single cartridge 130.

The cartridge mounting unit 60 is fitted for the complex cartridge 120 or the single cartridge 130 to be attached or detached. The cartridge mounting unit 60 includes the identification sensor 61, the identification button 62, and the inlet connector 64.

The identification sensor 61 is provided to the cartridge mounting unit 60 to identify a mounting of the cartridge and to transmit a cartridge mounting signal to the control unit 70.

Also, the identification sensor 61 identifies the kind of cartridge mounted to the cartridge mounting unit 60 to transmit a cartridge identification signal to the control unit 70. The cartridge identification signal is a signal indicating whether the cartridge installed to the cartridge mounting unit 60 is the complex cartridge 120 or the single cartridge 130. The identification button 62 is installed to the identification sensor 61 and identifies the kind of mounted cartridge according to whether or not the identification button 62 is pushed when the cartridge is mounted.

For this, the single cartridge 130 includes a button groove 135 in which the identification button 62 is inserted, and the complex cartridge 120 may not include the button groove. When mounting the complex cartridge 120 to the cartridge mounting unit 60, the identification button 62 is pushed, and the identification sensor 61 transmits a cartridge identification signal to the control unit 70 as an on signal. When installing the single cartridge 130 to the cartridge mounting unit 60, the identification button 62 is inserted to the button groove 135 such that the identification button 62 is not pushed and the identification sensor 61 transmits the cartridge identification signal as an off signal to the control unit 70.

In this case, the single cartridge 130 includes the button groove 135 and the complex cartridge 120 does not include the button groove. However, in other embodiments, the single cartridge 130 may not include the button groove and the complex cartridge 120 may include the button groove.

The identification sensor 61 identifies the kind of mounted cartridge by using the identification button 62. With regard to the identification sensor 61, various devices such as a limit sensor, a photoelectric sensor, a proximity sensor, an electromagnetic sensor, a pressure a sensor, and an infrared sensor can be used for this purpose.

The control unit 70 controls each operation of the fuel pump 41, the oxidant pump 42, the mixture solution control pump 50, and the first mixture solution control valve 51. In detail, it the control unit 70 receives the measurement signal of the concentration and the residual amount of the fuel mixture solution stored in the mixer 40 from the mixture solution sensor 43 and receives the mounting signal and the cartridge identification signal of the cartridge from the identification sensor 61. The control unit 70 compares a stored reference concentration with the measured fuel concentration for the contents of mixer 40 and compares a stored reference quantity of fuel mixture with the measured level of the fuel mixture solution contents of mixer 40.

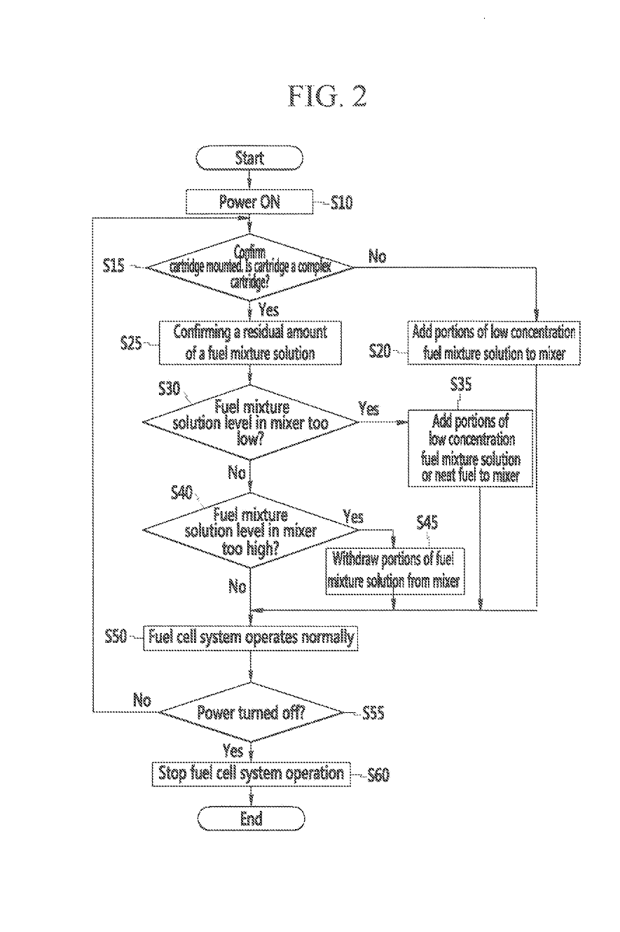

The detailed operation for controlling each operation of the fuel pump 41, the oxident pump 42, the mixture solution control pump 50, and the first mixture solution control valve 51 for the control unit 70 to adjust the concentration and the fuel mixture solution level in the mixer 40 will be described with reference to FIG. 2.

The complex cartridge 120 includes a mixture solution storage unit 121, a fuel storage unit 122, a second mixture solution control valve 123, and an outlet connector 124.

The mixture solution storage unit 121 is supplied with the low concentration fuel mixture solution. In the direct methanol fuel cell system, the mixture solution storage unit 121 may be supplied with the low concentration methanol mixture solution of from about 2 to about 8 vol %.

The fuel storage unit 122 stores the pure fuel. In the direct methanol fuel cell system, the fuel storage unit 122 may store pure methanol.

The second mixture solution control valve 123 is the three-way valve connected to the mixture solution storage unit 121, the fuel storage unit 122, and the outlet connector 124. The complex cartridge 120 is mounted to the cartridge mounting unit 60, the second mixture solution control valve 123 is electrically connected to the control unit 70, and the mixture solution storage unit 121 and the outlet connector 124 communicate with each other and the fuel storage unit 122 and the outlet connector 124 communicate with each other according to the control of the control unit 70.

The outlet connector 124 of the complex cartridge 120 is connected to the inlet connector 64 of the fuel cell apparatus 110.

The single cartridge 130 includes a mixture solution storage unit 131, a third mixture solution control valve 133, an outlet connector 134, and the button groove 135.

The mixture solution storage unit 131 stores the low concentration fuel mixture solution. In the direct methanol fuel cell system, the mixture solution storage unit 131 may store the low concentration methanol mixture solution of from about 2 to about 8 vol %.

If the single cartridge 130 is mounted to the cartridge mounting unit 60, the third mixture solution control valve 133 is electrically connected to the control unit 70, and the mixture solution storage unit 131 and the outlet connector 124 communicate with each other according to the control of the control unit 70.

The outlet connector 134 of the single cartridge 130 is connected to the inlet connector 64 of the fuel cell apparatus 110.

The button groove 135 provides a contact surface with the cartridge mounting unit 60 for the identification button 62 to be inserted into when the single cartridge 130 is mounted to the cartridge mounting unit 60.

Now, the operation in which the fuel cell system 100 establishes the predetermined concentration and the predetermined quantity level of the fuel mixture solution in the mixer 40 will be described with reference to FIG. 2.

FIG. 2 is a flowchart of a method for driving a fuel cell system according to an exemplary embodiment of the present invention.

Referring to FIG. 2, the power to the fuel cell apparatus 110 is turned on (S10).

If the fuel cell apparatus 110 is turned on, the control unit 70 receives a cartridge mounting signal from the identification sensor 61 to determine whether the cartridge is mounted. When the cartridge is mounted to the cartridge mounting unit 60, the control unit 70 determines whether the cartridge identification signal is the on signal (S15). If the complex cartridge 120 is mounted to the cartridge mounting unit 60, the identification button 62 is pushed, and the identification sensor 61 transmits the cartridge identification signal, an on signal, to the control unit 70. If the single cartridge 130 is mounted to the cartridge mounting unit 60, the identification button 62 is inserted to the button groove 135 without the push, and the identification sensor 61 transmits the cartridge identification signal as an off signal to the control unit 70.

If the cartridge identification signal receives the off signal, the control unit 70 determines that the single cartridge 130 storing the low concentration fuel mixture solution is mounted to the cartridge mounting unit 60. The control unit 70 performs a process of adjusting the concentration of the fuel mixture solution by adding portions of the low concentration fuel mixture solution stored in the single cartridge 130 to the mixer 40 as needed (S20).

The process of adjusting the concentration of the fuel mixture solution by adding portions of the low concentration fuel mixture solution stored in the single cartridge 130 to the mixer 40 can be performed as follows.

The control unit 70 receives the measurement signal of the concentration and the residual amount of the fuel mixture solution stored in the mixer 40 from the mixture solution sensor 43 and determines whether the quantity of the fuel mixture solution stored in the mixer 40 is insufficient. If the quantity of the fuel mixture solution stored in the mixer 40 is insufficient, the control unit 70 controls the first mixture solution control valve 51 such that the mixture solution control pump 50 and the inlet connector 64 communicate with each other, and the control unit 70 controls the third mixture solution control valve 133 such that the mixture solution storage unit 131 and the outlet connector 134 communicate with each other. The control unit 70 drives the mixture solution control pump 50 to move the low concentration fuel mixture solution stored in the mixture solution storage unit 131 of the single cartridge 130 to the mixer 40. The control unit 70 monitors whether the residual amount of the fuel mixture solution of the mixer 40 reaches the reference level by using the mixture solution sensor 43.

When the quantity of the fuel mixture in the mixer 40 reaches the reference level, the control unit stops pumping the low concentration fuel mixture solution with the mixture solution control pump 50.

When the quantity of the fuel mixture solution stored in the mixer 40 is sufficient, the process (S20) of adding the low concentration fuel mixture solution to the fuel mixture solution in the mixer 40 is stopped.

If the cartridge identification signal receives the on signal, the control unit 70 determines that the complex cartridge 120 is mounted to the cartridge mounting unit 60.

The control unit 70 receives the measurement signal from the mixture solution sensor to confirm the concentration and the residual amount of the fuel mixture solution stored in the mixer 40 (S25). Moisture along with unreacted fuel from the condenser is added to the mixer 40, and the concentration of the fuel mixture solution stored in the mixer 40 is thereby gradually a decreased. The control unit 70 confirms whether the concentration of the fuel mixture solution stored in the mixer 40 is lower than the reference concentration. Also, the control unit 70 confirms whether the residual quantity of the fuel mixture solution stored in the mixer 40 is lower or higher than the reference level.

The control unit 70 determines whether the quantity of the fuel mixture solution stored in the mixer 40 is insufficient (S30). That is, the control unit 70 determines whether the quantity of the fuel mixture solution stored in the mixer 40 is below the reference level.

When the quantity of the fuel mixture solution stored in the mixer 40 is insufficient, the control unit 70 performs a process of adding portions of the low concentration fuel mixture solution and the pure fuel stored in the complex cartridge 120 to the fuel mixture solution in the mixer 40 (S35).

The process of adding portions of the low concentration fuel mixture solution and the pure fuel stored in the complex cartridge 120 to the fuel mixture solution in the mixer 40 can be performed as follows.

When the concentration of the fuel mixture solution stored in the mixer 40 is lower than the reference concentration, the control unit 70 controls the first mixture solution control valve 51 such that the mixture solution control pump 50 and the inlet connector 64 communicate with each other, and the control unit 70 controls the second mixture solution control valve 123 such that the fuel storage unit 122 and the outlet connector 124 communicate with each other. Also, the control unit 70 drives the mixture solution control pump 50 to move the pure fuel stored in the fuel storage unit 122 to the mixer 40 such that the concentration of the fuel mixture solution of the mixer 40 reaches the reference concentration. At this time, the control unit 70 monitors the concentration measurement signal of the mixture solution sensor 43 to confirm a whether the concentration of the fuel mixture solution of the mixer 40 has reached the reference concentration.

If the concentration of the fuel mixture solution stored in the mixer 40 reaches the reference concentration, the control unit 70 controls the second mixture solution control valve 123 to communicate the mixture solution storage unit 121 and the outlet connector 124. Also, the control unit 70 drives the mixture solution control pump 50 to move the low concentration fuel mixture solution stored in the mixture solution storage unit 121 to the mixer 40. The control unit 70 monitors the residual measurement signal of the mixture solution sensor 43 to confirm whether the residual quantity of the fuel mixture solution in the mixer 40 reaches the reference level. When the fuel mixture solution in the mixer 40 reaches the reference level, the mixture solution control pump 50 is stopped.

If the process of adding the fuel mixture solution to the mixer 40 is finished, the control unit 70 operates the fuel cell stack 10 to generate electrical energy (S50). The control unit 70 operates the fuel cell stack 10, and simultaneously the process of adding additional fuel mixture solution to the mixer 40 can be performed.

As the fuel cell stack 10 is operated according to the direct methanol fuel cell, carbon dioxide, hydrogen ions, and electrons are generated by the reaction of the methanol and the water at the anode of the fuel cell stack 10, as shown in Chemical Formula 1.

CH₃OH+H₂O→CO₂+6H⁺+6e⁻ Chemical Formula 1

Hydrogen ions generated in the anode of the fuel cell stack 10 are transmitted to the cathode through the electrolyte membrane. In the cathode, as shown in Chemical Formula 2, the water is generated by the reaction between hydrogen ions, electrons transmitted through an external circuit, and oxygen.

3/2O₂+6H⁺+6e⁻→3H₂O Chemical Formula 2

The entire reaction of the fuel cell stack 10 according to the direct methanol fuel cell is the reaction generating water and carbon dioxide by reacting methanol and oxygen as in Chemical Formula 3.

CH₃OH+3/2O₂→2H₂O+CO₂ Chemical Formula 3

As shown in Chemical Formula 3, one mole of methanol and one and one half moles of oxygen are reacted to generate 2 moles of water.

As the fuel cell stack 10 is operated, the generated water is transmitted to the mixer 40 through the gas-liquid separator 20. Accordingly, the concentration of the fuel mixture solution stored in the mixer 40 decreases and the quantity of the fuel mixture solution increases to become greater than the reference amount.

Meanwhile, when the quantity of the fuel mixture solution stored in the mixer 40 is sufficient, the control unit 70 determines whether the residual amount of the fuel mixture solution of the mixer 40 is excessive (S40). That is, the control unit 70 monitors whether the residual amount of the fuel mixture solution of the mixer 40 is greater than the reference amount preset in the mixture solution sensor 43.

When the residual amount of the fuel mixture solution of the mixer 40 is excessive, the control unit 70 performs a process of withdrawing the fuel mixture solution from the mixer 40 (S45).

The process of withdrawing the fuel mixture solution from the mixer 40 may be performed as follows.

The control unit 70 controls the first mixture solution control valve 51 to communicate the mixture solution control pump 50 and the inlet connector 64. Also, the control unit 70 controls the second mixture solution control valve 123 to communicate the mixture solution storage unit 121 and the outlet connector 124. The control unit 70 drives the mixture solution control pump 50 to move the fuel mixture solution stored in the mixer 40 to the mixture solution storage unit 121. The control unit 70 monitors the residual measurement signal of the mixture solution sensor 43 to confirm whether the residual amount of the fuel mixture solution of the mixer 40 reaches the reference amount. If the residual amount of the fuel mixture solution of the mixer 40 reaches the reference amount, the control unit 70 stops the driving of the mixture solution control pump 50.

In the process of withdrawing the fuel mixture solution from the mixer 40, the concentration of the fuel mixture solution stored in the mixer 40 can be adjusted to the reference concentration. This can be done by adding portions of low concentration fuel mixture solution until a reference concentration is reached.

When the process of withdrawing the fuel mixture solution from the mixer 40 is finished, the control unit 70 operates the fuel cell stack 10 (S50). While the control unit 70 operates the fuel cell stack 10, the process of withdrawing the fuel mixture solution from the mixer 40 can be simultaneously performed.

The control unit 70 frequently determines whether the operation of the fuel cell apparatus 110 should be discontinued because the power from the fuel cell apparatus 110 has been turned off (S55). If the power of the fuel cell apparatus 110 is not of the processes from the process S15 of determining whether the cartridge identification signal shows the on signal through process S55 are performed again. That is, the process S35 of adding the fuel mixture solution to the mixer 40 and the process S45 of withdrawing the fuel mixture solution from the mixer 40 are repeated while the fuel cell stack 10 is operated.

If the power of the fuel cell apparatus 110 is off the control unit 70 stops the operation of the fuel cell stack 10 (S60).

As described, when the quantity of the fuel mixture solution is not sufficient, the fuel mixture solution is added to the mixer 40 by using the complex cartridge 120, and when the quantity of the fuel mixture solution is excessive in the mixer 40, the fuel mixture solution is withdrawn to the mixture solution storage unit 121 of the complex cartridge 120 to maintain the fuel mixture solution at the reference level in the mixer 40. Also, simultaneous with the process of adding the fuel mixture solution to the mixer 40 and the process of withdrawing the fuel mixture solution from the mixer 40, the pure fuel stored in the fuel storage unit 122 of the complex cartridge 120 is supplied to the mixer 40 such that the concentration of the fuel mixture solution stored in the mixer 40 is brought to the reference concentration.

When using the single cartridge 130 stored with the low concentration fuel mixture solution, the process of supplementing the fuel mixture solution in the mixer 40 with the low concentration fuel mixture solution in the single cartridge 130 may be performed. However, when the quantity of the fuel mixture solution is excessive in the mixer 40, the process of withdrawing the fuel mixture solution is not performed. Accordingly, the fuel mixture solution that is excessive in the mixer 40 can overflow the fuel mixture solution, and to prevent this, the fuel cell apparatus 110 has a separate exhausting means for exhausting the fuel mixture solution and a storing means for storing the exhausted fuel mixture solution.

However, when using the complex cartridge 120 including the mixture solution storage unit 121 and the fuel storage unit 122, the fuel cell apparatus 110 does not require the separate exhausting means and storing means.

The above drawings and detailed description are embodiments of the present invention and are provided by way of example, and the scope of the present invention described in the claims is not limited thereto. Therefore, it will be appreciated by those skilled in the art that various modifications may be made and other equivalent embodiments are available. Accordingly, the actual spirit and scope of the present invention is limited only by the appended claims.

<Description of Symbols>

```
  10: fuel cell stack
  20: gas-liquid separator
  30: condenser
  40: mixer
  41: fuel pump
  42: oxidant pump
  43: mixture solution sensor
  50: mixture solution control pump
  51: first mixture solution control valve
  60: cartridge mounting unit
  61: identification sensor
  62: identification button
  70: control unit
100: fuel cell system
110: fuel cell apparatus
120: complex cartridge
130: single cartridge
```

What is claimed is:

1. A fuel cell apparatus comprising:
a fuel cell stack including a plurality of unit cells;
a mixer storing a fuel mixture solution supplied to the fuel cell stack;
a mixture solution sensor measuring a residual amount of the fuel mixture solution stored in the mixer;
a mixture solution control pump supplying the fuel mixture solution stored in a cartridge to the mixer and withdrawing the fuel mixture solution stored in the mixer to the cartridge; and
a control unit receiving a residual measurement signal of the fuel mixture solution stored in the mixer from the mixture solution sensor, driving the mixture solution control pump to supply the fuel stored in the cartridge to the mixer if the residual amount of the fuel mixture solution stored in the mixer is below a reference amount, and driving the mixture solution control pump to withdraw the fuel mixture solution stored in the mixer to the cartridge if the residual amount of the fuel mixture solution stored in the mixer exceeds the reference amount.

2. The fuel cell apparatus of claim 1, further comprising:
a pump supplying air to the fuel cell stack; and
a gas-liquid separator separating unreacted air and unreacted fuel exhausted from the fuel cell stack into a liquid and a gas.

3. The fuel cell apparatus of claim 2, further comprising a condenser condensing the gas separated in the gas-liquid separator to withdraw the unreacted fuel.

4. The fuel cell apparatus of claim 3, further comprising:
a cartridge mounting unit including an inlet connector connected to an outlet connector of the cartridge; and
an identification sensor identifying a kind of the cartridge.

5. The fuel cell apparatus of claim 4, further comprising a first mixture solution control valve connected to the mixture solution control pump, the condenser, and the inlet connector.

6. The fuel cell apparatus of claim 4, wherein the identification sensor includes an identification button, and a kind of the mounted cartridge is identified through a push of the identification button when mounting the cartridge to the cartridge mounting unit.

7. The fuel cell apparatus of claim 6, wherein the cartridge mounting unit is mounted with one of a complex cartridge storing a low concentration fuel mixture solution and pure fuel and a single cartridge storing the low concentration fuel mixture solution, the low concentration fuel mixture solution having a fuel concentration of from about 2 to about 8 vol %.

8. The fuel cell apparatus of claim 7, wherein one of the complex cartridge and the single cartridge includes a button groove inserted with the identification button.

9. The fuel cell apparatus of claim 7, wherein the complex cartridge includes:
a mixture solution storage unit storing the low concentration fuel mixture solution;
a fuel storage unit storing the pure fuel;
an outlet connector connected to the inlet connector; and
a second mixture solution control valve communicating one of the mixture solution storage unit and the fuel storage unit with the outlet connector.

10. The fuel cell apparatus of claim 9, wherein the control unit controls the second mixture solution control valve when supplying the fuel to the mixer to communicate the mixture solution storage unit and the outlet connector.

11. The fuel cell apparatus of claim 9, wherein the control unit controls the second mixture solution control valve when withdrawing the fuel mixture solution from the mixer to communicate the mixture solution storage unit and the outlet connector.

12. The fuel cell apparatus of claim 9, wherein:
the mixture solution sensor measures the concentration of the fuel mixture solution stored in the mixer to transmit concentration measuring information to the control unit, and
the control unit controls the second mixture solution control valve to communicate the fuel storage unit and the outlet connector if the concentration of the fuel mixture solution stored in the mixer is below the reference concentration.

13. A complex cartridge comprising:
a mixture solution storage unit storing a low concentration fuel mixture solution, the low concentration fuel mixture solution having a fuel concentration of from about 2 to about 8 vol %;
a fuel storage unit storing a pure fuel;
a connector connected to a cartridge mounting unit of a fuel cell apparatus; and
a control valve communicating one of the mixture solution storage unit and the fuel storage unit with the connector.

14. The complex cartridge of claim 13, wherein if the fuel cell apparatus is mounted, the control valve is a three-way valve that is electrically connected to the fuel cell apparatus such that one of the mixture solution storage unit and the fuel storage unit communicates with the connector according to the control of the fuel cell apparatus.

15. The complex cartridge of claim 13, further comprising a button groove inserted with an identification button provided to the cartridge mounting unit of the fuel cell apparatus to identify a kind of the cartridge.

16. A method of driving a fuel cell apparatus, comprising:
providing a fuel cell stack;
providing a mixer for storing a quantity of a fuel mixture solution that is to be supplied to the fuel cell stack;
providing a complex cartridge comprising a mixture solution storage unit storing a low concentration fuel mixture solution and a fuel storage unit storing a pure fuel, the low concentration fuel mixture solution having a fuel concentration of from about 2 to about 8 vol %;
confirming a residual amount of the fuel mixture solution stored in the mixer;
determining whether the quantity of the fuel mixture solution stored in the mixer is below a reference level;
moving the low concentration fuel mixture solution from the mixture solution storage unit to the mixer to supplement the fuel mixture solution of the mixer if the quantity of the fuel mixture solution of the mixer is below a reference level;
determining whether the quantity of the fuel mixture solution stored in the mixer exceeds the reference level; and
moving the fuel mixture solution stored in the mixer to the mixture solution storage unit to decrease the fuel mixture level in the mixer if the quantity of the fuel mixture solution stored in the mixer exceeds the reference level.

17. The method of claim 16, wherein the confirming of the residual amount of the fuel mixture solution stored in the mixer includes confirming a concentration of the fuel mixture solution stored in the mixer.

18. The method of claim 17, further comprising the step of moving the pure fuel from the fuel storage unit to the mixer to make the concentration of the fuel mixture solution stored in the mixer reach the reference concentration if the concentration of the fuel mixture solution stored in the mixer is lower than the reference concentration.

19. The method of claim 16, wherein the step of moving the low concentration fuel mixture solution from the mixture solution storage unit to the mixer to supplement the fuel mixture solution of the mixer if the quantity of the fuel mixture solution of the mixer is below a reference level and the step of moving the fuel mixture solution stored in the mixer to the mixture solution storage unit to decrease the fuel mixture level in the mixer if the quantity of the fuel mixture solution stored in the mixer exceeds the reference level are repeatedly performed while the fuel cell stack included in the fuel cell apparatus is operated.
